(19) United States
(12) Patent Application Publication
(10) Pub. No.: US 2025/0328050 A1
(43) Pub. Date: Oct. 23, 2025

(54) CHOLESTERIC LIQUID CRYSTAL DISPLAY DEVICE

(71) Applicant: Iris Optronics Co., Ltd., Tainan City (TW)

(72) Inventors: Chi Chang LIAO, Tainan City (TW); Ching Shan LIN, Kaohsiung City (TW); Hui Che LIN, Tainan City (TW); Jung Chih CHOU, Tainan City (TW)

(21) Appl. No.: 19/185,203

(22) Filed: Apr. 21, 2025

Related U.S. Application Data
(60) Provisional application No. 63/637,564, filed on Apr. 23, 2024.

(30) Foreign Application Priority Data
Apr. 14, 2025 (TW) 114114057

(51) Int. Cl. G02F 1/137; G02F 1/1362

(52) U.S. Cl. CPC G02F 1/13718; G02F 1/13629

(57) ABSTRACT

A cholesteric liquid crystal display device includes a lower substrate, a lower electrode layer, a pixel layer, an upper electrode layer, a plurality of supporting members, and an upper substrate. The lower electrode layer is disposed on a surface of the lower substrate. The pixel layer is connected to the lower electrode layer. The upper electrode layer is connected to the pixel layer, so as to make the pixel layer be arranged between the lower electrode layer and the upper electrode layer. The plurality of supporting members are disposed between the lower electrode layer and the upper electrode layer. The upper substrate is connected to the upper electrode layer, so as to make the upper electrode layer be disposed between the pixel layer and the upper substrate.

### RELATED APPLICATIONS

This application claims priority to U.S. Provisional Application Ser. No. 63/637,564, filed Apr. 23, 2024, and Taiwan Application Serial Number 114114057, filed Apr. 14, 2025, which is herein incorporated by reference.

### BACKGROUND

### Technical Field

The present disclosure relates to a liquid crystal display device. More particularly, the present disclosure relates to a cholesteric liquid crystal display device which can reduce reflected light of affecting the display effect.

### Description of Related Art

The cholesteric liquid crystal display device is a display device that utilizes cholesteric liquid crystals to reflect external light to display images. The conventional cholesteric liquid crystal display device includes a substrate, a lower electrode layer, a liquid crystal layer and an upper electrode layer stacked in sequence. An electric field is applied to the liquid crystal layer by the lower electrode layer and the upper electrode layer, so as to adjust the state of the cholesteric liquid crystals in the liquid crystal layer. Furthermore, the conventional cholesteric liquid crystal display device further includes a protection portion, which is disposed between the substrate and the lower electrode layer to provide a protective effect.

Referring to FIG. 5, FIG. 5 is a partial top schematic view of the matrix portion 910 and the protection portion 920 of the conventional cholesteric liquid crystal display device. From FIG. 5, it can be understood that in the conventional cholesteric liquid crystal display device, the protection portion 920 covers a large area of the surface of the lower substrate (not shown). Thus, when external light passes through the pixel layer (not shown), a significant amount of light is reflected by the protection portion 920, which affects the display image of the pixel layer, and further reduces the contrast and optical performance of the conventional cholesteric liquid crystal display device.

In this regard, how to reduce the reflection problem between the substrate and the lower electrode layer of the cholesteric liquid crystal display device, has become a goal for the relevant industries.

### SUMMARY

According to an embodiment of the present disclosure, a cholesteric liquid crystal display device includes a lower substrate, a lower electrode layer, a pixel layer, an upper electrode layer, a plurality of supporting members, and an upper substrate. The lower electrode layer is disposed on a surface of the lower substrate. The pixel layer is connected to the lower electrode layer. The upper electrode layer is connected to the pixel layer, so as to make the pixel layer be arranged between the lower electrode layer and the upper electrode layer. The plurality of supporting members are disposed between the lower electrode layer and the upper electrode layer. The upper substrate is connected to the upper electrode layer, so as to make the upper electrode layer be disposed between the pixel layer and the upper substrate.

According to another embodiment of the present disclosure, a cholesteric liquid crystal display device includes a lower substrate, a plurality of component layers, a lower electrode layer, a pixel layer, an upper electrode layer, a plurality of supporting members, an upper substrate, and a plurality of matrix portions. The plurality of component layers are respectively disposed on a surface of the lower substrate. The lower electrode layer covers the surface of the lower substrate and the plurality of component layers. The pixel layer is connected to the lower electrode layer. The upper electrode layer is connected to the pixel layer, so as to make the pixel layer be arranged between the lower electrode layer and the upper electrode layer. The plurality of supporting members are disposed between the lower electrode layer and the upper electrode layer, wherein the plurality of supporting members are respectively aligned with the plurality of component layers. The upper substrate is connected to the upper electrode layer, so as to make the upper electrode layer be disposed between the pixel layer and the upper substrate. The plurality of matrix portions are disposed between the upper electrode layer and the upper substrate, wherein the plurality of matrix portions are respectively aligned with the plurality of supporting members.

### BRIEF DESCRIPTION OF THE DRAWINGS

FIG. 1 is a cross-sectional schematic view of a cholesteric liquid crystal display device according to the first embodiment of the present disclosure.

FIG. 2 is a cross-sectional schematic view of a cholesteric liquid crystal display device according to the second embodiment of the present disclosure.

FIG. 3 is a cross-sectional schematic view of a cholesteric liquid crystal display device according to the third embodiment of the present disclosure.

FIG. 4 is a partial top schematic view of the plurality of matrix portions and the plurality of protection portions of the cholesteric liquid crystal display device according to the third embodiment.

FIG. 5 is a partial top schematic view of the matrix portion and the protection portion of the conventional cholesteric liquid crystal display device.

### DETAILED DESCRIPTION

The present disclosure will be further exemplified by the following specific embodiments. However, the embodiments can be applied to various inventive concepts and can be embodied in various specific ranges. The specific embodiments are only for the purposes of description, and are not limited to these practical details thereof. Furthermore, in order to simplify the drawings, some conventional structures and elements will be illustrated in the drawings by a simple and schematic way. The duplicated elements may be denoted by the same number or similar numbers.

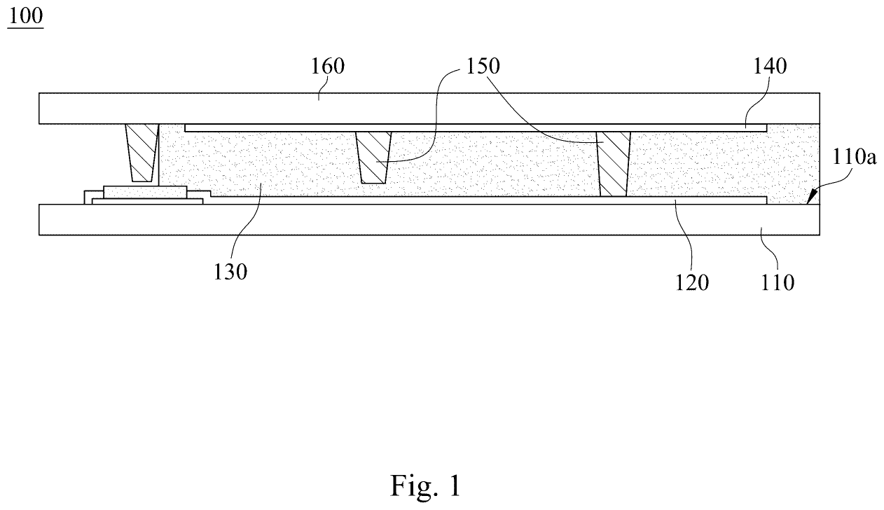

Referring to FIG. 1, FIG. 1 is a cross-sectional schematic view of a cholesteric liquid crystal display device 100 according to the first embodiment of the present disclosure. The cholesteric liquid crystal display device 100 includes a lower substrate 110, a lower electrode layer 120, a pixel layer 130, an upper electrode layer 140, a plurality of supporting members 150, and an upper substrate 160.

In detail, the lower electrode layer 120 is disposed on a surface 110a of the lower substrate 110, the pixel layer 130 is connected to the lower electrode layer 120, and the upper electrode layer 140 is connected to the pixel layer 130, so as to make the pixel layer 130 be arranged between the lower electrode layer 120 and the upper electrode layer 140. Therefore, the lower electrode layer 120 and the upper electrode layer 140 can be configured to control the pixel layer 130 for display, and no other structural layers are disposed between the lower electrode layer 120 and the lower substrate 110, which significantly reduces the reflected light at the interface of the lower electrode layer 120 and the lower substrate 110, and improves the contrast of the cholesteric liquid crystal display device 100.

The plurality of supporting members 150 are disposed between the lower electrode layer 120 and the upper electrode layer 140, and the upper substrate 160 is connected to the upper electrode layer 140, so as to make the upper electrode layer 140 be disposed between the pixel layer 130 and the upper substrate 160. Therefore, the plurality of supporting members 150 provide good support, so as to maintain an appropriate spacing between the lower substrate 110 and the upper substrate 160. Moreover, a width (not labeled) of each of the plurality of supporting members 150 adjacent to the lower electrode layer 120 can be smaller than a width (not labeled) of each of the plurality of supporting members 150 adjacent to the upper electrode layer 140, which gives each of the plurality of supporting members 150 a trapezoidal structure as shown in FIG. 1. However, the present disclosure is not limited to the shapes of the plurality of supporting members 150.

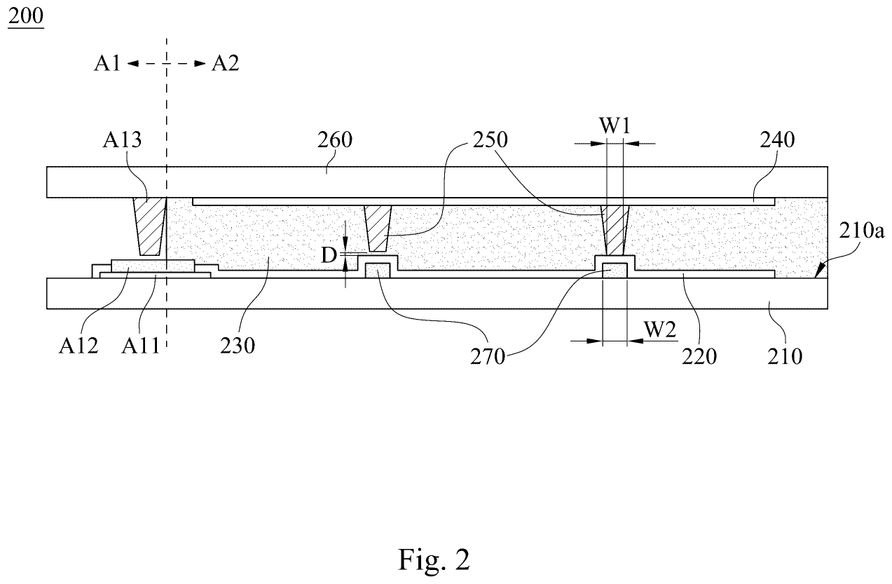

Referring to FIG. 2, FIG. 2 is a cross-sectional schematic view of a cholesteric liquid crystal display device 200 according to the second embodiment of the present disclosure. In the second embodiment, the structural configuration of the cholesteric liquid crystal display device 200 is the same or similar to the structural configuration of the cholesteric liquid crystal display device 100 of the first embodiment, and the same structures will not be described again herein.

The cholesteric liquid crystal display device 200 can further include a plurality of protection portions 270, which are disposed between the lower substrate 210 and the lower electrode layer 220. The plurality of protection portions 270 are respectively aligned with the plurality of supporting members 250, that is, the plurality of protection portions 270 are only disposed at the positions corresponding to the plurality of supporting members 250. Therefore, the plurality of protection portions 270 can provide protective effects where the plurality of supporting members 250 are disposed, which simultaneously avoids excessive light reflection at the positions where no supporting members 250 are arranged, so as to ensure that the cholesteric liquid crystal display device 200 has good optical performance.

Furthermore, each of the plurality of supporting members 250 has a first width W1, and each of the plurality of protection portions 270 has a second width W2, and the second width W2 can be larger than the first width W1. Therefore, the plurality of protection portions 270 can be larger than the plurality of supporting members 250 to provide good protection effect.

Furthermore, a gap distance D can be formed between each of the plurality of supporting members 250 and the lower electrode layer 220, which makes the pixel layer 230 on both sides of the plurality of supporting members 250 to remain communicated, so as for the fluid medium of the pixel layer 230 to flow.

The cholesteric liquid crystal display device 200 can further include a non-display area A1. That is, the cholesteric liquid crystal display device 200 can include a non-display area A1 and a display area A2, and the pixel layer 230 is disposed in the display area A2. The non-display area A1 can include a plurality of metal wiring layers A11, a protection portion A12, and a non-display area supporting member A13. The plurality of metal wiring layers A11 can be disposed on the surface 210a of the lower substrate 210, the protection portion A12 can be disposed on the plurality of metal wiring layers A11, and the non-display area supporting member A13 can be disposed between the upper substrate 260 and the lower substrate 210 and disposed above the protection portion A12. Therefore, a sufficient space can be provided in the non-display area A1 for the arrangement of circuits or other components.

It should be mentioned that the cholesteric liquid crystal display device 100 of the first embodiment and the cholesteric liquid crystal display device 200 of the second embodiment can be passive matrix liquid crystal display devices, which can control the liquid crystal alignment through a grid-like structure formed by the lower electrode layer 120 and the upper electrode layer 140, or the lower electrode layer 220 and the upper electrode layer 240.

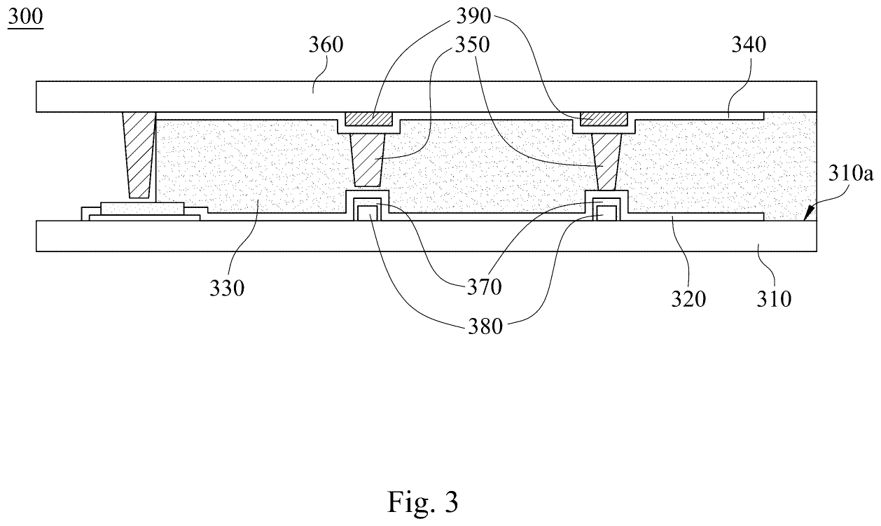

Referring to FIG. 3, FIG. 3 is a cross-sectional schematic view of a cholesteric liquid crystal display device 300 according to the third embodiment of the present disclosure. The cholesteric liquid crystal display device 300 includes a lower substrate 310, a plurality of component layers 380, a lower electrode layer 320, a pixel layer 330, an upper electrode layer 340, a plurality of supporting members 350, an upper substrate 360, and a plurality of matrix portions 390. The structural configuration of the lower substrate 310, the lower electrode layer 320, the pixel layer 330, the upper electrode layer 340, the plurality of supporting members 350, and the upper substrate 360 is the same or similar to the structural configuration of the cholesteric liquid crystal display device 100 of the first embodiment, and the same structures will not be described again herein.

In detail, the plurality of component layers 380 are disposed on the surface 310a of the lower substrate 310, the lower electrode layer 320 covers the surface 310a of the lower substrate 310 and the plurality of component layers 380, and the plurality of supporting members 350 are respectively aligned with the plurality of component layers 380. Therefore, the required component layers 380 can be disposed between the lower electrode layer 320 and the lower substrate 310, which simultaneously avoids the plurality of component layers 380 from causing light reflection that could affect the optical performance of the cholesteric liquid crystal display device 300. Furthermore, the plurality of protection portions 370 can be respectively cover the plurality of component layers 380, which provides the protective effect and prevents light reflection from the plurality of protection portions 370.

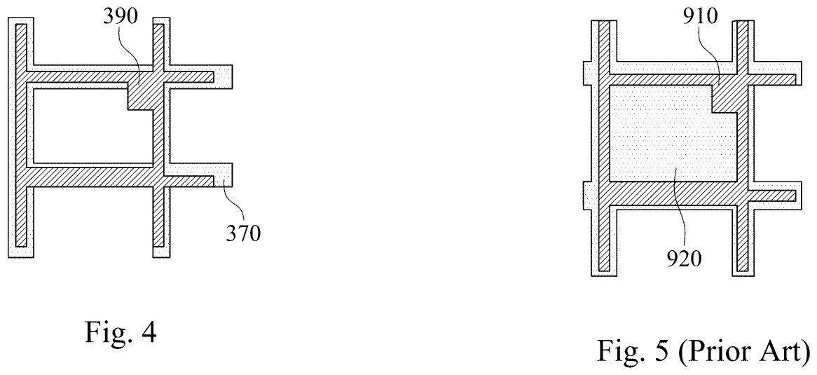

Referring to FIG. 4, FIG. 4 is a partial top schematic view of the plurality of matrix portions 390 and the plurality of protection portions 370 of the cholesteric liquid crystal display device 300 according to the third embodiment. From FIG. 3 and FIG. 4, it can be understood that the plurality of matrix portions 390 are disposed between the upper electrode layer 340 and the upper substrate 360, and the plurality of matrix portions 390 are respectively aligned with the plurality of supporting members 350. Therefore, the plurality of matrix portions 390 can be configured to control the pixel layer 330 for display. Because the plurality of protection portions 370 cover the plurality of component layers 380, the overlap region between the plurality of protection portions 370 and the pixel layer 330 is minimized, which avoids excessive light reflection caused by the plurality of protection portions 370.

Furthermore, referring to FIG. 5, FIG. 5 is a partial top schematic view of the matrix portion 910 and the protection portion 920 of the conventional cholesteric liquid crystal display device. From FIG. 4 and FIG. 5, it can be understood that the area occupied by the plurality of protection portions 370 of the cholesteric liquid crystal display device 300 of the present disclosure is smaller than the area occupied by the protection portion 920 in the conventional cholesteric liquid crystal display device, so the reflected light caused by the plurality of protection portions 370 can be significantly reduced. Therefore, the cholesteric liquid crystal display device 300 of the present disclosure can perform greater contrast performance than the conventional cholesteric liquid crystal display devices.

It should be mentioned that the cholesteric liquid crystal display device 300 of the third embodiment can be an active matrix liquid crystal display device, which can control individual pixels in the pixel layer 330 for display by the plurality of matrix portions 390.

In summary, by reducing or eliminating the structure between the lower electrode layer and the lower substrate in the cholesteric liquid crystal display device of the present disclosure, the full functionality of the cholesteric liquid crystal display device can be ensured, and the reflected light at the interface of the lower electrode layer and the lower substrate can be significantly reduced, which improves the contrast and optical performance of the cholesteric liquid crystal display device.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A cholesteric liquid crystal display device, comprising:
a lower substrate;
a lower electrode layer disposed on a surface of the lower substrate;
a pixel layer connected to the lower electrode layer;
an upper electrode layer connected to the pixel layer, so as to make the pixel layer be arranged between the lower electrode layer and the upper electrode layer;
a plurality of supporting members disposed between the lower electrode layer and the upper electrode layer; and
an upper substrate connected to the upper electrode layer, so as to make the upper electrode layer be disposed between the pixel layer and the upper substrate.

2. The cholesteric liquid crystal display device of claim 1, further comprising a plurality of protection portions disposed between the lower substrate and the lower electrode layer.

3. The cholesteric liquid crystal display device of claim 2, wherein the plurality of protection portions are respectively aligned with the plurality of supporting members.

4. The cholesteric liquid crystal display device of claim 3, wherein each of the plurality of supporting members has a first width, each of the plurality of protection portions has a second width, and the second width is larger than the first width.

5. The cholesteric liquid crystal display device of claim 1, further comprising a non-display area, wherein the non-display area comprises:
a plurality of metal wiring layers disposed on the surface of the lower substrate;
a protection portion disposed on the plurality of metal wiring layers; and
a non-display area supporting member disposed between the upper substrate and the lower substrate and disposed above the protection portion.

6. The cholesteric liquid crystal display device of claim 1, wherein a width of each of the plurality of supporting members adjacent to the lower electrode layer is smaller than a width of each of the plurality of supporting members adjacent to the upper electrode layer.

7. The cholesteric liquid crystal display device of claim 1, wherein a gap distance is formed between each of the plurality of supporting members and the lower electrode layer.

8. A cholesteric liquid crystal display device, comprising:
a lower substrate;
a plurality of component layers respectively disposed on a surface of the lower substrate;
a lower electrode layer covering the surface of the lower substrate and the plurality of component layers;
a pixel layer connected to the lower electrode layer;
an upper electrode layer connected to the pixel layer, so as to make the pixel layer be arranged between the lower electrode layer and the upper electrode layer;
a plurality of supporting members disposed between the lower electrode layer and the upper electrode layer, wherein the plurality of supporting members are respectively aligned with the plurality of component layers;
an upper substrate connected to the upper electrode layer, so as to make the upper electrode layer be disposed between the pixel layer and the upper substrate; and
a plurality of matrix portions disposed between the upper electrode layer and the upper substrate, wherein the plurality of matrix portions are respectively aligned with the plurality of supporting members.

9. The cholesteric liquid crystal display device of claim 8, further comprising a plurality of protection portions disposed between the lower substrate and the lower electrode layer.

10. The cholesteric liquid crystal display device of claim 9, wherein the plurality of protection portions are respectively aligned with the plurality of supporting members, and the plurality of protection portions respectively cover the plurality of component layers.

11. The cholesteric liquid crystal display device of claim 10, wherein each of the plurality of supporting members has a first width, each of the plurality of protection portions has a second width, and the second width is larger than the first width.

12. The cholesteric liquid crystal display device of claim 8, further comprising a non-display area, wherein the non-display area comprises:
a plurality of metal wiring layers disposed on the surface of the lower substrate;
a protection portion disposed on the plurality of metal wiring layers; and
a non-display area supporting member disposed between the upper substrate and the lower substrate and disposed above the protection portion.

13. The cholesteric liquid crystal display device of claim 8, wherein a width of each of the plurality of supporting members adjacent to the lower electrode layer is smaller than a width of each of the plurality of supporting members adjacent to the upper electrode layer.

14. The cholesteric liquid crystal display device of claim 8, wherein a gap distance is formed between each of the plurality of supporting members and the lower electrode layer.
